(19) United States
(12) Patent Application Publication
(10) Pub. No.: US 2017/0069103 A1
(43) Pub. Date: Mar. 9, 2017

(54) KINEMATIC QUANTITY MEASUREMENT FROM AN IMAGE

(71) Applicant: Microsoft Technology Licensing, LLC, Redmond, WA (US)

(72) Inventors: Juuso Gren, Kyroskoski (FI); Tomi Sokeila, Kirkland, WA (US)

(21) Appl. No.: 14/847,358

(22) Filed: Sep. 8, 2015

(51) Int. Cl. G06T 7/20; G06K 9/62

(52) U.S. Cl. CPC G06T 7/20; G06K 9/6202

(57) ABSTRACT

A camera has known parameters that affect image distortions. Different shutters or different image sensor scanning procedures lead to the image having parts that are recorded at different moments. An object in motion may be recorded in different positions, which is usually seen as a distortion effect in the image. Detecting the object in the partial images in different positions enables the calculation of the position difference between two moments. As the time difference is known from the camera parameters, several kinematic quantities relating to the object may be calculated. Examples of the kinematic quantities are speed, velocity, angular velocity, acceleration and angular acceleration.

### BACKGROUND

Camera systems can be used for many purposes aside from traditional photography. Digital or computational photography enables the use of cameras as measurement equipment. Cameras can be used to measure a number of very different variables, like distance, speed or frequency, but usually require purpose specific camera systems. Some information may be obtained from conventional images if the camera parameters are known; for example, motion blur may be used to estimate the speed of an object.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A camera has known parameters that affect image distortions. Different shutters or different image sensor scanning procedures lead to the image having parts that are recorded at different moments. An object in motion may be recorded in different positions, which is usually seen as a distortion effect in the image. Detecting the object in the partial images in different positions enables the calculation of the position difference between two moments. As the time difference is known from the camera parameters, several kinematic quantities relating to the object may be calculated. Examples of the kinematic quantities are speed, velocity, angular velocity, acceleration and angular acceleration.

Many of the attendant features will be more readily appreciated as they become better understood by reference to the following detailed description considered in connection with the accompanying drawings. The embodiments described below are not limited to implementations which solve any or all of the disadvantages of known imaging apparatuses integrated in hand-held devices.

### DESCRIPTION OF THE DRAWINGS

The present description will be better understood from the following detailed description read in light of the accompanying drawings, wherein:

FIG. 1 illustrates a device according to an embodiment;

FIG. 2 illustrates two examples of an image distortion on a horizontally moving object; and

FIG. 3 illustrates two examples of an image distortion on a spinning object.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples are described and illustrated herein as being implemented in a smartphone, the device described is provided as an example and not a limitation. As those skilled in the art will appreciate, the present examples are suitable for application in a variety of different types of apparatuses that have the ability to capture an image or to detect features in the image.

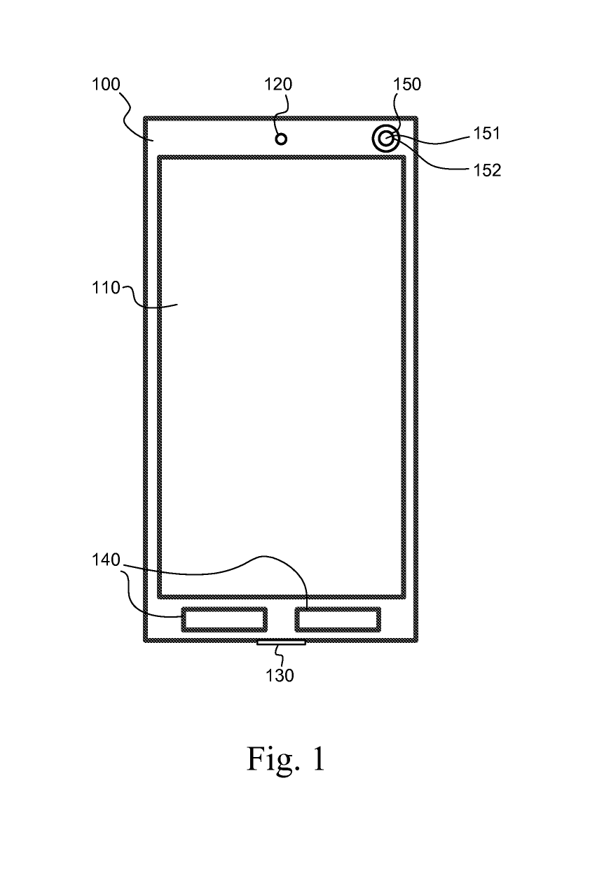

FIG. 1 illustrates a device according to an embodiment, wherein the device is a smartphone. The device comprises a body 100 comprising a display 110, a speaker 120, a microphone 130, keys 140 and a camera 150. The camera 150 comprises an image sensor 151 and a lens 152. The device comprises at least one processor and at least one memory including computer program code for one or more programs. The at least one memory and the computer program code are configured, with the at least one processor, to cause the apparatus to perform at least the functionality described herein. The system described hereinafter may comprise a portion of the portable device, its components and/or peripherals connected to the portable device.

In an embodiment, the image sensor 151 of the camera 150 is configured to capture an image in two portions. A first portion of the image is captured at a first moment. The moment is defined herein as a short period of time required to capture at least a portion of an image with a digital image sensor 151. A second portion is captured at a second moment. The first portion and the second portion may differ in size; also, the first moment and the second moment may differ in duration. The smallest possible image portion comprises the information of a single image sensor pixel. The whole image may comprise more than two portions. The camera 150 may comprise a memory and a processor. Alternatively, in an embodiment a device operates the camera 150 with the memory and at least one processor. The processor and the memory may cause the camera to capture the image in at least two portions. The image sensor 151 may scan the image in portions, in a sweeping action or in a scattered order. The processor may cause the image sensor to capture the image in at least two portions by controlling a mechanical shutter in front of the image sensor 151.

In an embodiment, the processor detects the time difference between the first moment and the second moment. The processor may receive the information of the time difference from the camera 150 operating the shutter. The time difference may be obtained from the timing information of image sensor pixels. The image sensor pixels have a predetermined position that relates to the position captured in the image. In an embodiment, the processor detects a position difference of an object in the first portion of the image and in the second portion of the image. The object may be an individual feature in a larger entity, such as a recognizable shape, an edge or a contrast having a recognizable form. The object may be a small marker, a sign or a bright spot such as light. Examples of an object include a ball, a corner, a laser pointer or structured light. The object may have a predetermined size and shape, for example a golf ball, a football or a hockey puck. A computing based image detection system may be used to detect the object in the first portion of the image. When the same object is detected in the second portion of the image that is captured at a different moment from the first portion of the image, the object has moved while capturing the image. Different portions in the image relate to different positions in the real world. The position difference of the object in the real world at different moments is proportional to the position difference in the first portion of the image and the second portion of the image. The time difference between the first moment and the second moment may be used with the position difference between the first portion of the image and the second portion of the image to calculate a kinematic quantity relating to the object. Examples of the kinematic quantities include speed, velocity, angular velocity, acceleration and angular acceleration. Kinematics is the branch of classical mechanics which describes the motion of objects or groups of objects without consideration of the causes of motion.

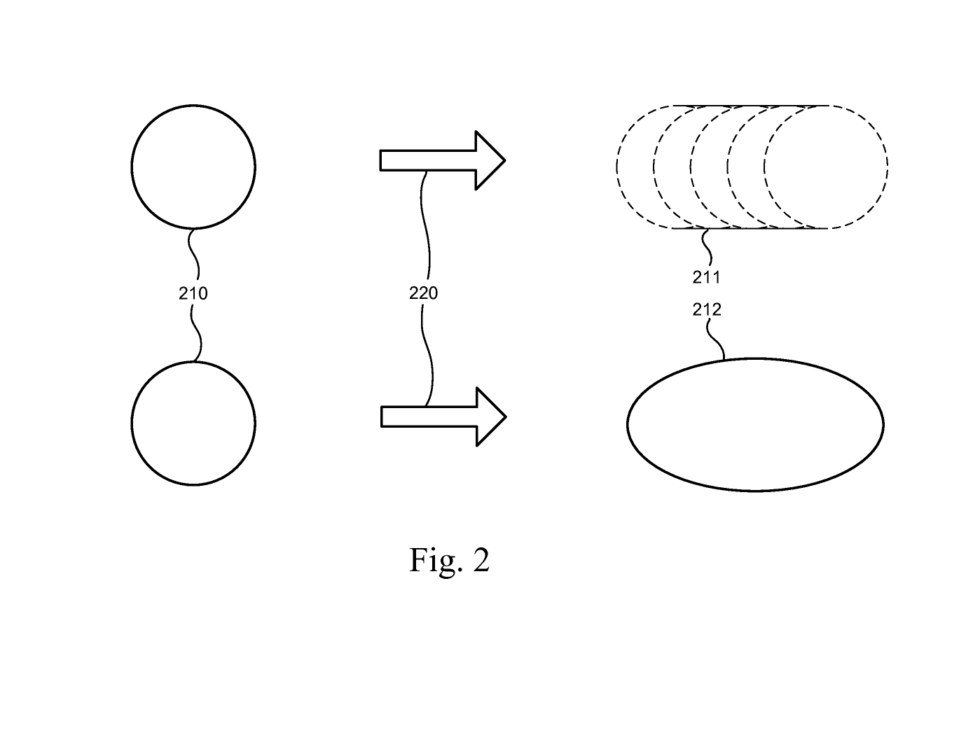

One example of a detectable object is illustrated in FIG. 2. A spherical object, a golf ball 210, has proceeded at a high velocity while the camera has captured an image. The high speed of the golf ball 210 causes distortions in the round image. Motion blur during the exposure of a portion of the image causes the golf ball to appear as a transparent, elongated object 211 in the direction of motion 220. The partial exposure of the image may cause the ball shape to become distorted; for example, the elliptical form 212 is caused by a rolling shutter effect when the direction of the rolling shutter is parallel to the motion 211 of the golf ball 210. As another example, the rolling shutter effect causes the elongated ball shape to become slanted when the direction of the rolling shutter is perpendicular to the motion of the golf ball 210. The rolling shutter effect is a phenomenon wherein lines of the image differ in the time domain - the lines have different temporal information. With predefined information, such as the shape of the object or distance from the camera, the differences between the individual lines may be analyzed. The time difference between each line is known from the camera parameters, whereby for example the speed or acceleration may be calculated. Depending on the prior information available, the direction of the motion may be determined as a motion vector. The device may be used for measuring the kinematic quantities for example in an environment where some parameters are fixed—such as roads, tracks or objects starting from a predetermined point where the initial position is known, such as a soccer penalty marker before a penalty kick.

In an embodiment, the camera 150 comprises a shutter to cause the image division into at least two portions. The portions may be seamlessly connected to each other, wherein the division into portions may be defined by a computing-based device such as a processor. Different types of shutters may be used, for example a leaf shutter, a focal-plane shutter, a diaphragm shutter or an electronic shutter. The shutter exposes different portions to capture the image at different moments.

In an embodiment, the image sensor may capture a HDR (High Dynamic Range) image, wherein the first portion of the image comprises several pixels distributed evenly in the image and the second portion comprises the neighboring pixels, also distributed evenly in the image. This method may also be used without the HDR function to reduce the rolling shutter effect.

In an embodiment, the computing-based device detects a shape of the moving object, for example a spherical object is detected as a ball. In an embodiment, the context of the detection is assigned as golf, so the device detects the spherical object as a golf ball. The device searches from the memory information about a shape of a similar stationary object, for example a stationary ball. The device compares the shape of the moving object in the captured image to the shape of the stationary object received from the memory and calculates, based on the comparison, at least one of speed, velocity, angular velocity, acceleration and angular acceleration of the object—at least one kinematic quantity.

In an embodiment, the device detects a shape of the object; searches from the memory information about a shape of a similar stationary object; compares the shape of the object in the captured image to the shape of the stationary object received from the memory using a transfer function and at least one camera lens distortion parameter; and calculates, based on the comparison, the distance between the object and the camera. In one embodiment, the device calculates a motion path of the object. The lens distortion parameters may be used to detect the distance or the motion path of an object. In many devices, the camera lens is not ideal; it may cause different optical distortions or aberrations. For example, a geometrical distortion is in many devices corrected by image processing. As an example, a single pixel-sized object in the center of the image may be reproduced as a single pixel in the image sensor, but at the corners one pixel-sized object may be spread into multiple image pixels—or vice versa. In an embodiment, the device comprises information about the shape of the object in the real world, for example a golf ball. The device calculates the transfer function to the image plane through the distortions, and may define for example the distance to the object, a depth camera vision. In one embodiment, the device defines the dimensions of the object, for example a diameter of the ball. In an embodiment, when the object is moving, for example between the frames or blurred within the frame, the device calculates the motion path based on the optical distortion information, wherein the object is optically slower or faster in different areas of the image. In an embodiment, the device detects movements of the camera on a predetermined motion path for example using a gyroscope or other motion sensor. The dimension or depth of the object is measured based on the predetermined motion information of the camera and the image distortion parameters. In an embodiment, the non-ideal parameters of the camera are enhanced to enable more accurate camera-based measurement results.

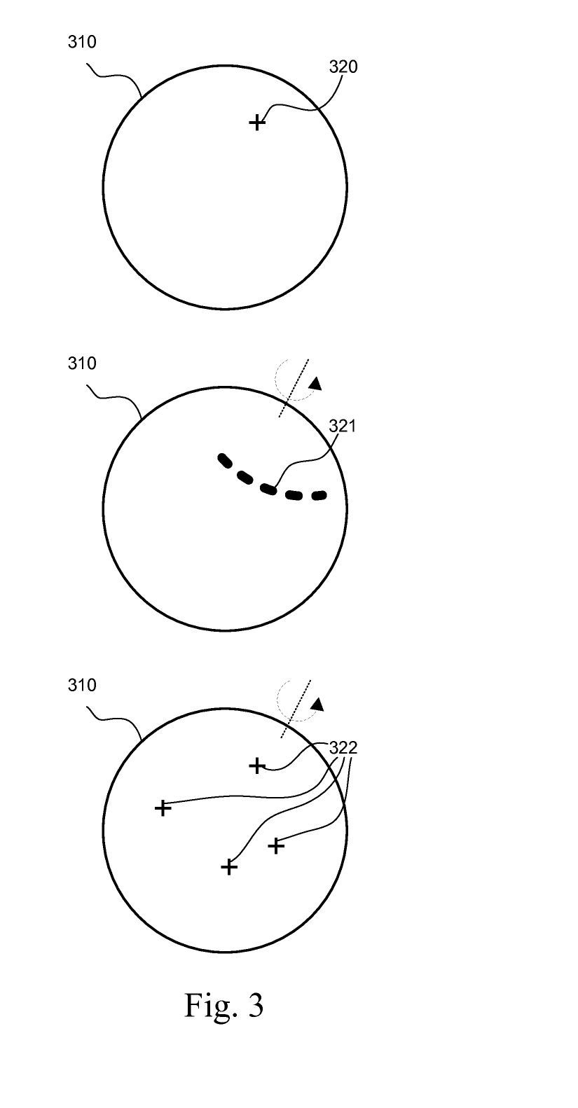

FIG. 3 shows one embodiment, wherein the computing-based device detects at least two traces of a marker on the object and calculates the rotating speed of the object as a response to the number of markers. For example, a golf ball 310 may have a high-speed spin. A single marker 320 may be a simple plus sign. Traces of the marker 320 may be captured as faint lines 321 on the ball, or as multiple markers 322. For example, a HDR image illustrates several marks with a time differential that may be used to detect the ball spin count.

In an embodiment, the image sensor comprises at least two areas configured to cause the first area to capture the first portion of the image at the first moment and the second area to capture the second portion of the image at the second moment. In an embodiment, the image sensor is configured to expose different pixels with a different exposure time, for example line-by-line. One image may comprise different exposure times, wherein the duration of the first moment is not equal to the duration of the second moment. This enables the measurement of the displacement and/or difference in the blur of the object between the exposures of the first image portion and the second image portion. The start or the end of the exposure may be constant. In an embodiment, the rolling shutter effect is varied for different exposures. For spin detection, this could be used for improving the detection range. If the spin is slow, the device selects longer exposure lines for a more accurate result and, for a fast spin, the device selects shorter exposure lines.

The camera may be used as measuring equipment. In many devices, the distortions or aberrations of the camera are not available to the user or the developer, as these anomalies are digitally corrected in the device. However, the distortions or aberrations may be used for measuring purposes. For example, mobile devices such as smartphones may be used as measuring equipment in various use cases as described hereinbefore.

One aspect discloses a device comprising: an image sensor configured to capture an image; at least one processor and a memory storing instructions that, when executed: cause the image sensor to capture a first portion of the image at a first moment and to capture a second portion of the image at a second moment, detect a time difference between the first moment and the second moment, detect a position difference of an object in the first portion of the image and in the second portion of the image; and calculate from the time difference and the position difference a kinematic quantity of the object. In an embodiment, the device comprises a shutter configured to cause the time difference between the first portion of the image and the second portion of the image. In an embodiment, the at least one processor and a memory storing instructions cause the device, when executed, to: detect a shape of the moving object; search from the memory information about a shape of a similar stationary object; compare the shape of the moving object in the captured image to the shape of the stationary object received from the memory; calculate, based on the comparison, at least one of speed, velocity, angular velocity, acceleration and angular acceleration of the object. In an embodiment, the device comprises a camera, wherein the at least one processor and a memory storing instructions cause the device, when executed, to: detect a shape of the object; search from the memory information about a shape of a similar stationary object; compare the shape of the object in the captured image to the shape of the stationary object received from the memory using a transfer function and at least one camera lens distortion parameter; and calculate, based on the comparison, the distance between the object and the camera. In an embodiment, the device comprises a camera having a lens, wherein the at least one processor and a memory storing instructions cause the device, when executed, to: detect a shape of the object; search from the memory information about a shape of a similar stationary object; compare the shape of the object in the captured image to the shape of the stationary object received from the memory using a transfer function and at least one camera lens distortion parameter; and calculate, based on the comparison, a motion path of the object. In an embodiment, the device comprises the at least one processor and a memory storing instructions that, when executed: detect at least two traces of a marker on the object and calculate the rotating speed of the object as a response to the number of markers.

One aspect discloses a system comprising: a camera configured to capture an image; at least one processor and a memory storing instructions that, when executed: cause the camera to capture a first portion of the image at a first moment and to capture a second portion of the image at a second moment, cause the camera to send a time difference between the first moment and the second moment to the at least one processor, cause the at least one processor to detect a position difference of an object in the first portion of the image and in the second portion of the image; and cause the at least one processor to calculate from the time difference and the position difference a kinematic quantity of the object. In an embodiment of the system, the camera comprises a shutter configured to cause the time difference between the first portion of the image and the second portion of the image. In an embodiment, the system comprises the at least one processor and a memory storing instructions that cause the system, when executed, to: detect a shape of the moving object; search from the memory information about a shape of a similar stationary object; compare the shape of the moving object in the captured image to the shape of the stationary object received from the memory; calculate, based on the comparison, at least one of speed, velocity, angular velocity, acceleration and angular acceleration of the object. In an embodiment, the system comprises at least one processor and a memory storing instructions that cause the system, when executed, to: detect a shape of the object; search from the memory information about a shape of a similar stationary object; compare the shape of the object in the captured image to the shape of the stationary object received from the memory using a transfer function and at least one camera lens distortion parameter; and calculate, based on the comparison, the distance between the object and the camera. In an embodiment, the system comprises the at least one processor and a memory storing instructions that cause the system, when executed, to: detect a shape of the object; search from the memory information about a shape of a similar stationary object; compare the shape of the object in the captured image to the shape of the stationary object received from the memory using a transfer function and at least one camera lens distortion parameter; and calculate, based on the comparison, a motion path of the object. In an embodiment, the camera comprises an image sensor configured to capture an image, the image sensor comprising at least two areas configured to cause the first area to capture the first portion of the image at the first moment and the second area to capture the second portion of the image at the second moment. In an embodiment, the system comprises at least one processor and a memory storing instructions that, when executed, cause the system to detect at least two traces of a marker on the object and calculate the rotating speed of the object as a response to the number of markers.

One aspect discloses a method, comprising: an image comprising at least one item of camera parameter data; the image comprising a first portion of the image captured at a first moment and a second portion of the image captured at a second moment, the camera parameter comprising a time difference between the first moment and the second moment, detecting a position difference of an object in the first portion of the image and in the second portion of the image; and calculating from the time difference and the position difference a kinematic quantity of the object. In an embodiment, the method comprises a shutter causing the time difference between the first portion of the image and the second portion of the image. In an embodiment, the method comprises at least one processor and a memory storing instructions for detecting a shape of the moving object; searching from the memory information about a shape of a similar stationary object; comparing the shape of the moving object in the image to the shape of the stationary object received from the memory; calculating, based on the comparison, at least one of speed, velocity, angular velocity, acceleration and angular acceleration of the object. In an embodiment, the method comprises detecting a shape of the moving object; searching from the memory information about a shape of a similar stationary object; comparing the shape of the moving object in the image to the shape of the stationary object received from the memory; calculating, based on the comparison, at least one of speed, velocity, angular velocity, acceleration and angular acceleration of the object. In an embodiment, the method comprises at least one processor and a memory storing instructions for detecting a shape of the object; searching from the memory information about a shape of a similar stationary object; the at least one camera parameter comprising a camera lens distortion parameter; comparing the shape of the object in the image to the shape of the stationary object received from the memory using a transfer function and the at least one camera lens distortion parameter; and calculating, based on the comparison, the distance between the object and the camera. In an embodiment, the method comprises detecting a shape of the object; searching from the memory information about a shape of a similar stationary object; the at least one camera parameter comprising a camera lens distortion parameter; comparing the shape of the object in the image to the shape of the stationary object received from the memory using a transfer function and the at least one camera lens distortion parameter; and calculating, based on the comparison, the distance between the object and the camera. In an embodiment, the method comprises at least one processor and a memory storing instructions for detecting a shape of the object; searching from the memory information about a shape of a similar stationary object; comparing the shape of the object in the captured image to the shape of the stationary object received from the memory using a transfer function and the at least one camera lens distortion parameter; and calculating, based on the comparison, a motion path of the object. In an embodiment, the method comprises detecting a shape of the object; searching from the memory information about a shape of a similar stationary object; comparing the shape of the object in the captured image to the shape of the stationary object received from the memory using a transfer function and the at least one camera lens distortion parameter; and calculating, based on the comparison, a motion path of the object. In an embodiment, the method comprises an image sensor configured to capture the image, the image sensor having a first area and a second area; and causing the first area to capture the first portion of the image at the first moment and the second area to capture the second portion of the image at the second moment. In an embodiment, the method comprises detecting at least two traces of a marker on the object and calculating the rotating speed of the object as a response to the number of markers.

Alternatively, or in addition, the functionality described herein can be performed, at least in part, by one or more hardware components or hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs). For example, some or all of the depth camera functionality, 3D imaging functionality or gesture detecting functionality may be performed by one or more hardware logic components.

An embodiment of the apparatus or a system described hereinbefore is a computing-based device comprising one or more processors which may be microprocessors, controllers or any other suitable type of processors for processing computer executable instructions to control the operation of the device in order to control one or more sensors, receive sensor data and use the sensor data. Platform software comprising an operating system or any other suitable platform software may be provided at the computing-based device to enable application software to be executed on the device.

The computer executable instructions may be provided using any computer-readable media that are accessible by a computing based device. Computer-readable media may include, for example, computer storage media such as memory and communications media. Computer storage media, such as a memory, include volatile and non-volatile, removable and non-removable media implemented in any method or technology for storage of information such as computer readable instructions, data structures, program modules or other data. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media do not include communication media. Therefore, a computer storage medium should not be interpreted to be a propagating signal per se. Propagated signals may be present in computer storage media, but propagated signals per se are not embodiments of computer storage media. Although the computer storage media are shown within the computing-based device it will be appreciated that the storage may be distributed or located remotely and accessed via a network or other communication link, for example by using a communication interface.

The computing-based device may comprise an input/output controller arranged to output display information to a display device which may be separate from or integral to the computing-based device. The display information may provide a graphical user interface, for example, to display hand gestures tracked by the device using the sensor input or for other display purposes. The input/output controller may also be arranged to receive and process input from one or more devices, such as a user input device (e.g. a mouse, keyboard, camera, microphone or other sensor). In some embodiments the user input device may detect voice input, user gestures or other user actions and may provide a natural user interface

(NUI). This user input may be used to configure the device for a particular user such as by receiving information about bone lengths of the user. In an embodiment the display device may also act as the user input device if it is a touch sensitive display device. The input/output controller may also output data to devices other than the display device, e.g. a locally connected printing device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Embodiments of tangible storage media include computer storage devices comprising computer-readable media such as disks, thumb drives, memory etc. and do not only include propagated signals. Propagated signals may be present in tangible storage media, but propagated signals per se are not embodiments of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an embodiment of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Although the subject matter has been described in language specific to structural features and/or acts, it is to be understood that the subject matter defined in the appended claims is not necessarily limited to the specific features or acts described above. Rather, the specific features and acts described above are disclosed as embodiments of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, embodiments and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A device comprising:
an image sensor configured to capture an image;
at least one processor and a memory storing instructions that, when executed:
cause the image sensor to capture a first portion of the image at a first moment and to capture a second portion of the image at a second moment,
detect a time difference between the first moment and the second moment,
detect a position difference of an object in the first portion of the image and in the second portion of the image; and
calculate from the time difference and the position difference a kinematic quantity of the object.

2. A device according to claim 1, comprising a shutter configured to cause the time difference between the first portion of the image and the second portion of the image.

3. A device according to claim 1, wherein the at least one processor and a memory storing instructions cause the device, when executed, to:
detect a shape of the moving object;
search from the memory information about a shape of a similar stationary object;
compare the shape of the moving object in the captured image to the shape of the stationary object received from the memory;
calculate, based on the comparison, at least one of speed, velocity, angular velocity, acceleration and angular acceleration of the object.

4. A device according to claim 1, comprising a camera, wherein the at least one processor and a memory storing instructions cause the device, when executed, to:
detect a shape of the object;
search from the memory information about a shape of a similar stationary object;
compare the shape of the object in the captured image to the shape of the stationary object received from the memory using a transfer function and at least one camera lens distortion parameter; and
calculate, based on the comparison, the distance between the object and the camera.

5. A device according to claim 1, comprising a camera having a lens, wherein the at least one processor and a memory storing instructions cause the device, when executed, to:
detect a shape of the object;
search from the memory information about a shape of a similar stationary object;
compare the shape of the object in the captured image to the shape of the stationary object received from the memory using a transfer function and at least one camera lens distortion parameter; and
calculate, based on the comparison, a motion path of the object.

6. A device according to claim 1, wherein the device comprises the at least one processor and a memory storing instructions that, when executed: detect at least two traces of a marker on the object and calculate the rotating speed of the object as a response to the number of markers.

7. A system comprising:
a camera configured to capture an image;
at least one processor and a memory storing instructions that, when executed:
cause the camera to capture a first portion of the image at a first moment and to capture a second portion of the image at a second moment,
cause the camera to send a time difference between the first moment and the second moment to the at least one processor,
cause the at least one processor to detect a position difference of an object in the first portion of the image and in the second portion of the image; and
cause the at least one processor to calculate from the time difference and the position difference a kinematic quantity of the object.

8. A system according to claim 7, the camera comprising a shutter configured to cause the time difference between the first portion of the image and the second portion of the image.

9. A system according to claim 7, wherein the at least one processor and a memory storing instructions cause the system, when executed, to:
detect a shape of the moving object;
search from the memory information about a shape of a similar stationary object;
compare the shape of the moving object in the captured image to the shape of the stationary object received from the memory;
calculate, based on the comparison, at least one of speed, velocity, angular velocity, acceleration and angular acceleration of the object.

10. A system according to claim 7, wherein the at least one processor and a memory storing instructions cause the system, when executed, to:
detect a shape of the object;
search from the memory information about a shape of a similar stationary object;
compare the shape of the object in the captured image to the shape of the stationary object received from the memory using a transfer function and at least one camera lens distortion parameter; and
calculate, based on the comparison, the distance between the object and the camera.

11. A system according to claim 7, wherein the at least one processor and a memory storing instructions cause the system, when executed, to:
detect a shape of the object;
search from the memory information about a shape of a similar stationary object;
compare the shape of the object in the captured image to the shape of the stationary object received from the memory using a transfer function and at least one camera lens distortion parameter; and
calculate, based on the comparison, a motion path of the object.

12. A system according to claim 7, wherein, in the camera comprising an image sensor configured to capture an image, the image sensor comprises at least two areas configured to cause the first area to capture the first portion of the image at the first moment and the second area to capture the second portion of the image at the second moment.

13. A system according to claim 7, wherein the system comprises the at least one processor and a memory storing instructions that, when executed, cause the system to detect at least two traces of a marker on the object and calculate the rotating speed of the object as a response to the number of markers.

14. A method, comprising:
an image comprising at least one item of camera parameter data;
the image comprising a first portion of the image captured at a first moment and a second portion of the image captured at a second moment,
the camera parameter comprising a time difference between the first moment and the second moment,
detecting a position difference of an object in the first portion of the image and in the second portion of the image; and
calculating from the time difference and the position difference a kinematic quantity of the object.

15. A method according to claim 14, comprising a shutter causing the time difference between the first portion of the image and the second portion of the image.

16. A method according to claim 14, comprising at least one processor and a memory storing instructions for:
detecting a shape of the moving object;
searching from the memory information about a shape of a similar stationary object;
comparing the shape of the moving object in the image to the shape of the stationary object received from the memory;
calculating, based on the comparison, at least one of speed, velocity, angular velocity, acceleration and angular acceleration of the object.

17. A method according to claim 14, comprising at least one processor and a memory storing instructions for:
detecting a shape of the object;
searching from the memory information about a shape of a similar stationary object;
the at least one camera parameter comprising a camera lens distortion parameter;
comparing the shape of the object in the image to the shape of the stationary object received from the memory using a transfer function and the at least one camera lens distortion parameter; and
calculating, based on the comparison, the distance between the object and the camera.

18. A method according to claim 14, comprising at least one processor and a memory storing instructions for:
detecting a shape of the object;
searching from the memory information about a shape of a similar stationary object;
comparing the shape of the object in the captured image to the shape of the stationary object received from the memory using a transfer function and the at least one camera lens distortion parameter; and
calculating, based on the comparison, a motion path of the object.

19. A method according to claim 14, comprising an image sensor configured to capture the image, the image sensor having a first area and a second area; and causing the first area to capture the first portion of the image at the first moment and the second area to capture the second portion of the image at the second moment.

20. A method according to claim 14, comprising detecting at least two traces of a marker on the object and calculating the rotating speed of the object as a response to the number of markers.
